(19) United States
(12) Patent Application Publication
(10) Pub. No.: US 2015/0356616 A1
(43) Pub. Date: Dec. 10, 2015

(54) GRAPHICAL USER INTERFACE IMPLEMENTED IN A MOBILE COMPUTING DEVICE THAT DISPLAYS ALTERNATE IMAGES TO COMMUNICATE A PRODUCT PURCHASE OR A PRODUCT PROMOTION TO A USER OF THE MOBILE COMPUTING DEVICE

(71) Applicant: TOSHIBA TEC KABUSHIKI KAISHA, Tokyo (JP)

(72) Inventors: Mina KODAMA, Ota Tokyo (JP); Yasuhiro ARAI, Mishima Shizuoka (JP); Kuniyoshi YAMADA, Ota Tokyo (JP); Tsuyoshi GOTANDA, Ota Tokyo (JP); Akiko SUSAKI, Ota Tokyo (JP)

(21) Appl. No.: 14/732,046

(22) Filed: Jun. 5, 2015

(30) Foreign Application Priority Data
Jun. 9, 2014 (JP) 2014-118943

(51) Int. Cl. G06Q 30/02

(52) U.S. Cl. CPC G06Q 30/0267; G06Q 30/0257; G06Q 30/0253

(57) ABSTRACT

A graphical user interface implemented in a mobile computing device of a user includes a plurality of user selectable regions and a processor. The user selectable regions include a first user selectable region being associated with a first product and displaying a first image, and a second user selectable region being associated with a second product and displaying a second image different from the first image. The processor is configured to recognize a selection of one of the user selectable regions. When the processor recognizes a user selection on the first user selectable region, the processor causes an enlarged version of the first image to be displayed. When the processor recognizes a user selection on the second user selectable region, the processor causes a third image to be displayed, the third image containing elements of a sales promotion for the second product.

### CROSS-REFERENCE TO RELATED APPLICATION

This application is based upon and claims the benefit of priority from Japanese Patent Application No. 2014-118943, filed Jun. 9, 2014, the entire contents of which are incorporated herein by reference.

### FIELD

Embodiments described herein relate generally to a graphical user interface implemented in a mobile computing device that displays alternate images to communicate a product purchase or a product promotion to a user of the mobile computing device.

### BACKGROUND

One type of an electronic receipt system transmits electronic data of a purchase transaction at a store (i.e., an electronic receipt) to a computing device of a customer, such as a mobile device, instead of issuing a conventional paper receipt that is handed to the customer upon completion of the purchase transaction.

The electronic receipt is useful to the customer, because the customer can manage his or her purchase transactions electronically. Further, the electronic receipt is useful to the store, because the store can reduce paper usage and with full conversion, will not need to invest in machines that issue the paper receipt. In addition, providing electronic receipts instead of paper receipts may reduce the time necessary to carry out settlement processing for the purchase transaction.

In addition, there is a method to promote sales of a particular product by including additional content (special content), such as background image (or sound, e.g., music), that can be displayed on a display unit of the computing device (or reproduced by the computing device), when the particular product is purchased. It would be convenient to the customer if the customer can easily recognize what product has been and has not been acquired by the customer.

### DESCRIPTION OF THE DRAWINGS

FIG. 1 illustrates an electronic receipt system according to an embodiment.

FIG. 2 is a block diagram of a POS terminal in the electronic receipt system.

FIG. 3 is a block diagram of a store server in the electronic receipt system.

FIG. 4 is a block diagram of a headquarter server in the electronic receipt system.

FIG. 5 is a block diagram of an electronic receipt server in the electronic receipt system.

FIG. 6 illustrates an example of data stored in an electronic receipt storage region.

FIG. 7 illustrates an example of data stored in a content condition storage region.

FIG. 8 is a block diagram of a portable terminal in the electronic receipt system.

FIG. 9 illustrates an example of a start screen of an electronic receipt application.

FIG. 10 illustrates an example of a display screen of an electronic receipt with a special content.

FIG. 11 illustrates an example of an initial screen of a content list screen.

FIG. 12 illustrates an example of a screen on which a content acquisition condition is displayed.

FIG. 13 illustrates an example of the content list screen after special contents have been acquired.

FIG. 14 illustrates an example of a content display screen.

FIG. 15 is a sequence diagram of a process of generating an electronic receipt with a special content, which is performed by the electronic receipt system.

FIG. 16 is a sequence diagram of a process of displaying a content list screen, which is performed by the electronic receipt system.

### DETAILED DESCRIPTION

An embodiment provides an information processing apparatus and a program which enables a user to easily view additional data added to an electronic receipt.

According to one embodiment, a graphical user interface implemented in a mobile computing device of a user includes a plurality of user selectable regions and a processor. The user selectable regions include a first user selectable region being associated with a first product and displaying a first image, and a second user selectable region being associated with a second product and displaying a second image different from the first image. The processor is configured to recognize a selection of one of the user selectable regions. When the processor recognizes a user selection on the first user selectable region, the processor causes an enlarged version of the first image to be displayed. When the processor recognizes a user selection on the second user selectable region, the processor causes a third image to be displayed, the third image containing elements of a sales promotion for the second product.

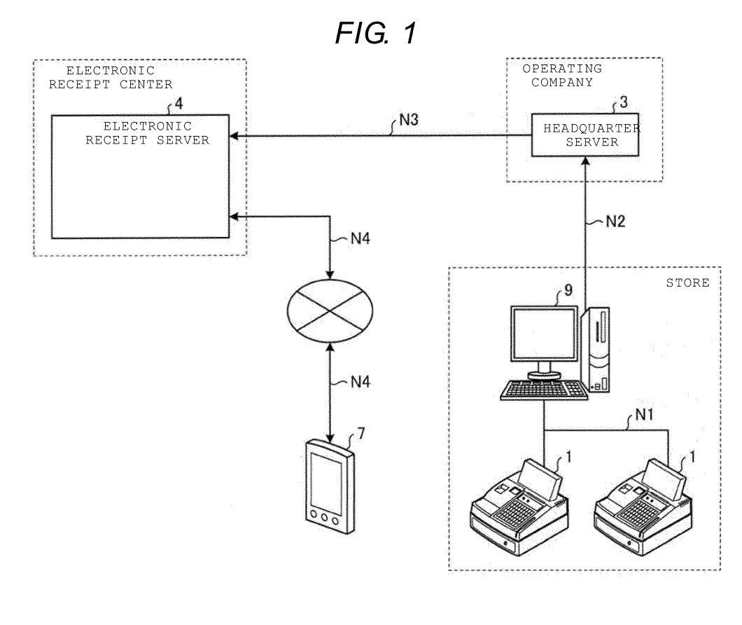

(1) System Configuration Example
FIG. 1 is a schematic diagram of an electronic receipt system according to an embodiment. As illustrated in FIG. 1, the electronic receipt system includes a point of sales (POS) terminal 1, a store server 9, a headquarter server 3, an electronic receipt server 4, and a portable terminal 7.

The POS terminal 1 and the store server 9 are located within a store. The POS terminal 1 and the store server 9 are connected to each other through a network N1, such as a local area network (LAN), within the store so as to be capable of communicating with each other. In addition, the POS terminal 1 and the store server 9 are configured to be connected to a network N2 through a network device (not shown), such as a router, which is connected to the network N1 within the store. The network N2 is a dedicated line that connects the store and a company (retailer) that operates the store. For example, the Internet, a virtual private network (VPN), and the like are used as the network. Meanwhile, the number of POS terminals 1 in the store is not particularly limited, and may be two or more.

The POS terminal 1 is a sales data processing apparatus that performs a sales data registration process. The POS terminal 1 generates an electronic receipt based on transaction data and outputs (transmits) the generated electronic receipt to the store server 9.

The store server 9 comprehensively performs processes such as sales data management and inventory control within a store. That is, the store server 9 receives transaction data, an electronic receipt, and the like from the POS terminal 1. The store server 9 stores such information in a storage unit, manages the information, and transmits the information to the headquarter server 3.

The headquarter server 3 is provided in the company (company headquarter) that comprehensively operates one or more stores (chain stores). The headquarter server 3 receives transaction data from the store server 9 of the store which is under the control thereof, and performs sales management, sales analysis, inventory control, and the like. In addition, the headquarter server 3 receives an electronic receipt from the store server 9 of each store through the network N2. The headquarter server 3 transmits the electronic receipt to an electronic receipt server 4 of an electronic receipt center through a network N3. Here, network N3 is a dedicated line such as, for example, the Internet or a VPN.

The electronic receipt server 4 is provided in the electronic receipt center. The electronic receipt center is an organization to which an electronic receipt service is delegated from the company that operates the stores. The electronic receipt server 4 receives an electronic receipt from the headquarter server 3 and manages the electronic receipt.

In addition, the electronic receipt server 4 associates special contents with an electronic receipt, based on transaction data included in the electronic receipt. The portable terminal 7 manages the special content in association with an electronic receipt to which the special content is to be added, so that the special content may also be displayed on a display screen of the electronic receipt and reproduced.

The special content refers to a content added for promotion to an electronic receipt of a purchase transaction when a purchase of specific merchandise or in a specific store is performed. The special content is, for example, an image displayed on a display screen of an electronic receipt a background image of an electronic receipt, or a video data reproducible on a display screen of an electronic receipt. Further, the special content maybe a sound reproduction which is reproduced in the display screen of the electronic receipt. In addition, a plurality of special contents may be added to one electronic receipt by combining these special contents.

When the electronic receipt server 4 receives a request for displaying an electronic receipt from the portable terminal 7, the electronic receipt server 4 transmits display data of the electronic receipt to the portable terminal 7 that has sent the request. In addition, when the electronic receipt is associated with the special content, display data of the electronic receipt and the special content is transmitted to the portable terminal 7.

In addition, the electronic receipt server 4 associates special contents already acquired by a customer (member) with member information and manages the special contents associated with member information for each member. The electronic receipt server 4 generates display data of a screen on which a special content is to be displayed independently from data of an electronic receipt, and transmits the data to the portable terminal 7 in response to the displaying request from the customer's portable terminal 7. An example of the screen display will be described below with reference to the drawings.

Here, a method of transmitting the display data is not particularly limited, and general-purpose protocol such as HTTP or HTTPS may be used. A transmission source of the displaying request is not limited to the portable terminal 7. A customer's information processing apparatus other than the headquarter server 3, the store server 9, the POS terminal 1, and the portable terminal 7, or other information processing apparatuses may request the displaying of an electronic receipt or a special content to the electronic receipt server 4.

Although an example in which an operating company delegates an electronic receipt service to an external electronic receipt center is shown in FIG. 1, the operating company may have a function of the electronic receipt server within the company headquarter. In other words, the electronic receipt system may include an information processing apparatus having functions of both the headquarter server 3 and the electronic receipt server 4.

The portable terminal 7 is a portable information processing terminal which is used by a user (member) of the electronic receipt system. A smartphone, a mobile phone, a personal digital assistant (PDA), a tablet computer, and the like may be used as the portable terminal 7. The portable terminal 7 includes a web browser, an application related to an electronic receipt, and the like, and accesses a web page uploaded on a network N4 by the electronic receipt server 4. The network N4 is a public communication network such as the Internet. The portable terminal 7 transmits a member code stored in its own apparatus to the electronic receipt server and requests the displaying of an electronic receipt associated with the member code. The portable terminal 7 displays an electronic receipt on a display unit 73 (see FIG. 8) based on the display data received from the electronic receipt server 4.

As described above, when a special content is attached to an electronic receipt, the portable terminal 7 also displays a special content associated with the electronic receipt data on the display unit 73 in a process of displaying the electronic receipt.

A format of the electronic receipt may not be the same as the format of a receipt printed on paper. However, the electronic receipt replaces a paper receipt, and serves as an electronic acknowledgment that verifies the purchase of merchandise and the reception of store's payment. Accordingly, it is preferable that information necessary for an acknowledgment includes a store name, a purchase date, details of purchased merchandise, a total price, a deposit amount, a change amount, a cash register number, a transaction number, and the like.

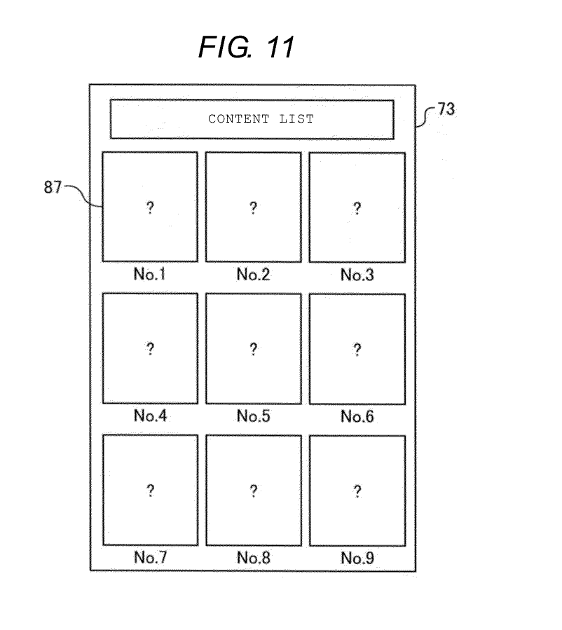

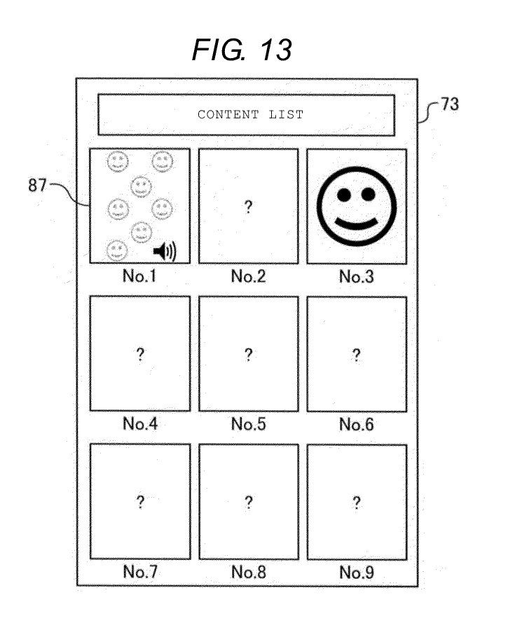

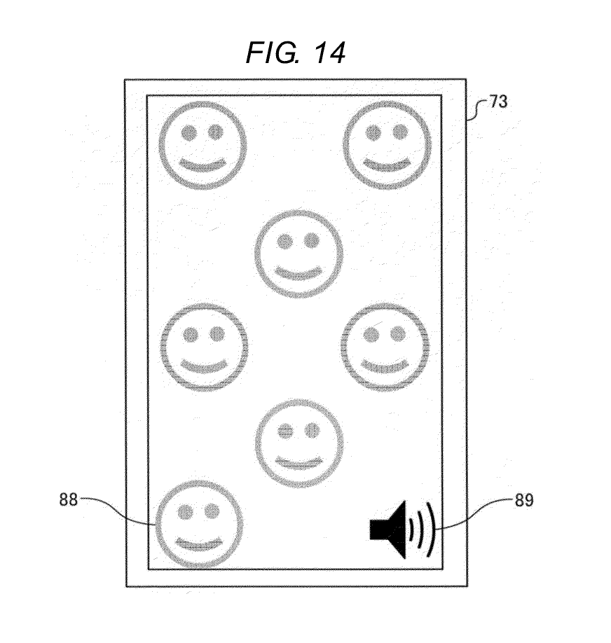

In addition, the portable terminal 7 displays a content list screen (see FIGS. 11 and 13) for displaying a list of special contents already acquired by a customer (member), on the display unit 73.

(2) Configuration Example of Device

(2-1) POS Terminal

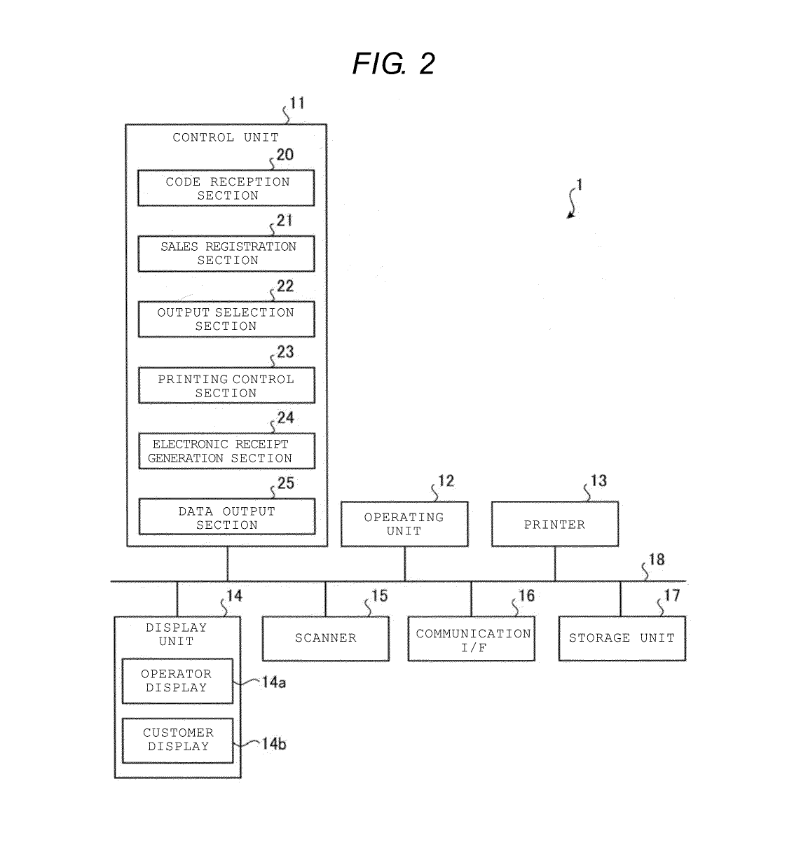

First, the configuration of the POS terminal 1 will be described. FIG. 2 is a block diagram of the POS terminal 1. As illustrated in FIG. 2, the POS terminal 1 includes a control unit 11 which includes a central processing unit (CPU), a read only memory (ROM), a random access memory (RAM), or the like. The control unit 11 is connected to an operating unit 12, a printer 13, a display unit 14, a scanner 15, a communication I/F (Interface) 16, a storage unit 17, and the like through a bus 18. The control unit 11 is also connected to the network N1 within the store through the communication I/F 16.

The operating unit 12 includes various operation keys with which an operator can perform input operations. The printer 13 performs printing of a receipt, a journal, and the like. For example, a liquid crystal display is used for the display unit 14. When a touch panel is provided on the surface of the display, the touch panel functions as the operating unit 12. The display unit 14 includes an operator display 14a that displays various kinds of information to a cashier and a customer display 14b that displays various kinds of information to a customer.

The scanner 15 optically reads a code symbol such as a bar code and a two-dimensional code. The scanner 15 decodes, for example, a code symbol printed on merchandise and a code symbol of a member code displayed on the portable terminal 7, and outputs the read data to the control unit 11.

The storage unit 17 is a storage device such as a hard disk drive (HDD) or a solid state drive (SSD). The storage unit 17 stores programs for performing a sales data registration process, an electronic receipt generation process, an electronic receipt output process, and the like. In addition, the storage unit 17 stores a merchandise master containing merchandise information such as a merchandise name, a merchandise code, and a price.

In addition, the storage unit 17 stores various identification codes. Examples of the identification codes include a POS number for identifying the POS terminal 1, a store code indicating a store in which the POS terminal 1 is installed, a company code which is an identification code of a company operating the store, a business type and business condition code which is a code for identifying a business type and business condition of a store, and the like. Meanwhile, examples of the business type and business condition of a store include a convenience store, a supermarket, a department store, a pharmacy, a restaurant, an eatery, and the like.

As illustrated in FIG. 2, when a program is executed by the POS terminal 1, modules including a code reception section 20, a sales registration section 21, an output selection section 22, a printing control section 23, an electronic receipt generation section 24, and a data output section 25 are generated. The CPU of the control section 11 develops the program to a RAM and executes the program, and thus the functions of the above-described sections are generated.

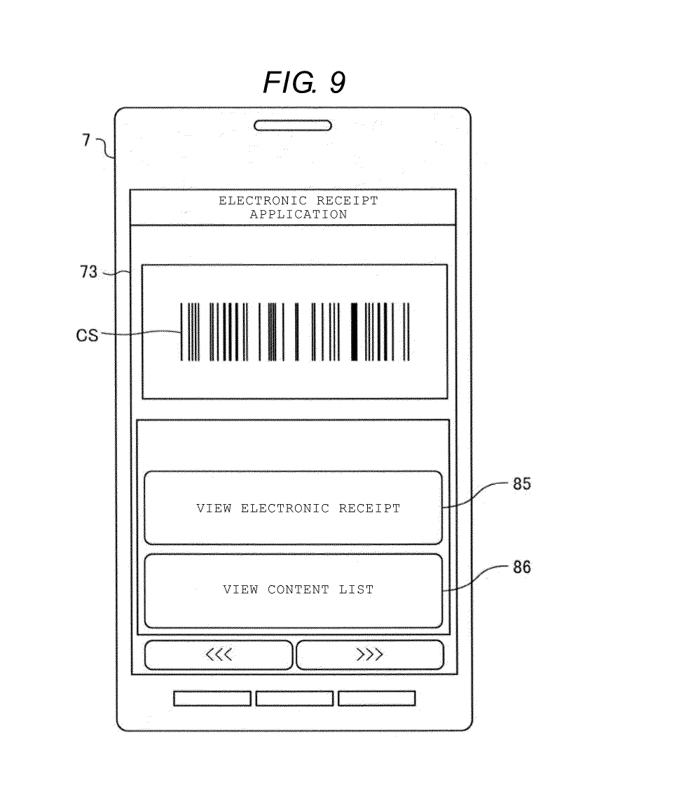

When the scanner 15 reads a code symbol printed on merchandise, the code reception section 20 recognizes a merchandise code decoded from the code symbol and receives the input thereof. In addition, the code reception section 20 recognizes a member code decoded from a code symbol CS (see FIG. 9) displayed on the display unit 73 (see FIG. 8) of the portable terminal 7 and receives the input thereof.

Alternatively, the code reception section 20 may receive the member code from the portable terminal 7 through another communication section such as near field wireless communication. A method such as near field communication (NFC) or Bluetooth (registered trademark) may be used for the near field wireless communication.

Further alternatively, the code reception section 20 may receive the member code from a medium such as an IC card or a magnetic card which contains the member code. When the IC card is used, the POS terminal 1 may include a reading and writing unit such as an IC card reader writer. In addition, when the magnetic card is used, the POS terminal 1 may include a card reader or a card writer of the magnetic card, and the like.

The sales registration section 21 reads merchandise information corresponding to the merchandise code from the merchandise master in response to the reception process by the code reception section 20, and temporarily registers the merchandise information in the RAM. In addition, the sales registration section 21 generates transaction data (receipt data) including merchandise information such as a merchandise name, a merchandise code, a merchandise price, and the number of merchandise items, information such as a total price, a total number of merchandise items, a deposit amount, and the change sum for one transaction, and information such as a transaction number (receipt number), a transaction date, a cash register number, and salesperson information, and stores the generated transaction data in the RAM.

The output selection section 22 selects whether to print out the transaction data on a receipt paper in accordance with a selection operation on the operating unit 12 or output the transaction data as an electronic receipt.

When the print-out of the paper receipt is selected through the output selection section 22, the printing control section 23 generates print data of the transaction data and outputs the generated print data to the printer 13. The printer 13 prints out a receipt based on the print data.

The electronic receipt generation section 24 converts receipt data in an unstructured format, which is registered by the sales registration section 21, into structured data and generates an electronic receipt. In addition, the electronic receipt generation section 24 includes the member code read by the code reception section 20 and various identification codes, such as a company code and a store code, which are stored in the storage unit 17, in the electronic receipt.

Alternatively, the headquarter server 3 may store the company code and the business type and business condition code. The headquarter server 3 may attach the codes to the electronic receipt received from the POS terminal 1 and transmit the electronic receipt having the codes attached thereto to the electronic receipt server 4.

When the electronic receipt generation section 24 generates an electronic receipt, the data output section 25 transmits the generated electronic receipt to the store server 9. Here, a timing of data output is not particularly limited, and the data may be output at predetermined time or at predetermined time intervals. In addition, an output destination and a method of passing through data are not particularly limited, and may be appropriately modified according to an embodiment.

In addition, the store server 9 and other information processing apparatuses may have the function of the electronic receipt generation section 24. The apparatus may receive transaction data from the POS terminal 1 and generate an electronic receipt, and may output the electronic receipt data to the outside.

(2-2) Store Server

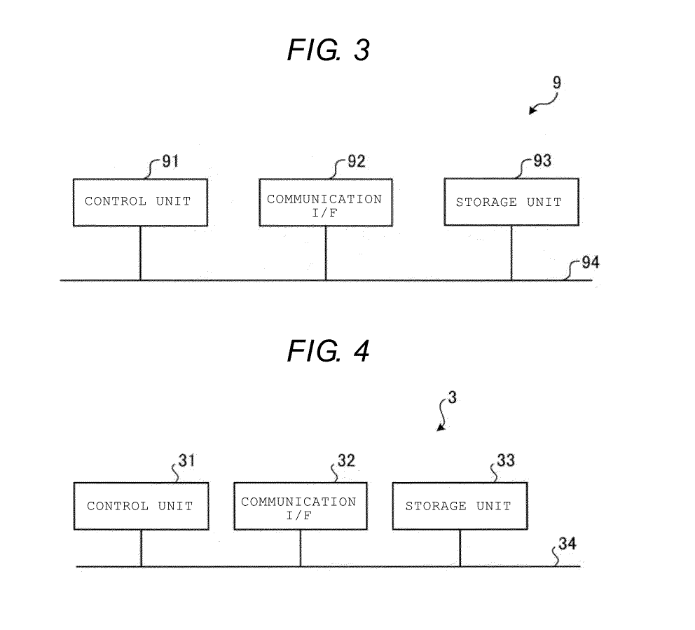

Next, the configuration of the store server 9 will be described. FIG. 3 is a block diagram of the store server 9. The store server 9 includes a control unit 91 including a CPU, a ROM, a RAM, or the like. The control unit 91 is connected to a communication I/F 92 and a storage unit 93 through a bus 94. In addition, an operating unit and an indicator (not shown in FIG. 3) may be connected to the control unit 91 through the bus 94 and various interfaces. The control unit 91 is connected to the network N1 and the network N2 through the communication I/F 92. The storage unit 93 stores a program for performing a sales data management process, an inventory control process, an electronic receipt transmission and reception process, an electronic receipt management process, and the like. The storage unit 93 also stores various data such as the merchandise master transmitted from the headquarter server 3 and an electronic receipt and sales data transmitted from the POS terminal 1 within the store. The control unit 91 performs the above-described processes by executing a program stored in the storage unit 93. As an example, the control unit 91 transmits data such as an electronic receipt and transaction data, which are received from the POS terminal 1, to the headquarter server 3.

(2-3) Headquarter Server

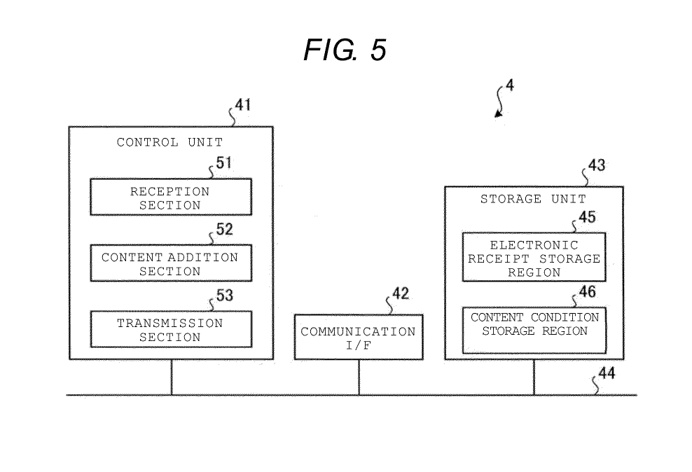

Next, the configuration of the headquarter server 3 of an operating company will be described. FIG. 4 is a block diagram of the headquarter server 3. The headquarter server 3 includes a control unit 31 including a CPU, a ROM, a RAM, or the like. The control unit 31 is connected to a communication I/F 32 and a storage unit 33 through a bus 34. In addition, an operating unit and an indicator (not shown in FIG. 5) are connected to the control unit 31 through the bus 34 and various interfaces. The control unit 31 is connected to the network N2 and the network N3 through the communication I/F 32. The storage unit 33 stores a program for performing a sales data management process, an inventory control process, an electronic receipt transmission and reception process, an electronic receipt management process, and the like. In addition, the storage unit 33 stores various data such as an electronic receipt and sales data which are transmitted from the store server 9 of the store. The control unit 31 performs the above-described processes by executing the program stored in the storage unit 33.

(2-4) Electronic Receipt Server

Next, the electronic receipt server 4 of the electronic receipt center will be described. FIG. 5 is a block diagram of the electronic receipt server 4. The electronic receipt server 4 includes a control unit 41 including a CPU, a ROM, a RAM, or the like. The control unit 41 is connected to a communication I/F 42 and a storage unit 43 through a bus 44. The control unit 41 is connected to the network N3 and the network N4 through the communication I/F 42.

The storage unit 43 contains an electronic receipt storage region 45 and a content condition storage region 46. The electronic receipt storage region 45 is a storage region for storing an electronic receipt received from the headquarter server 3 for each member. The content condition storage region 46 is a storage region in which conditions to attaching a special content to an electronic receipt are set.

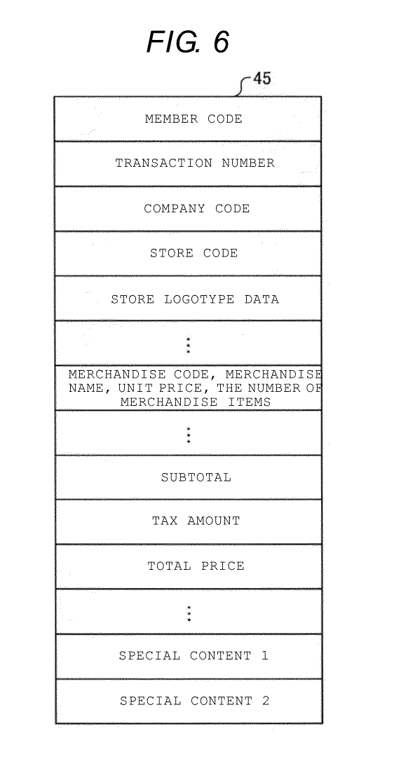

FIG. 6 illustrates an example of data stored the electronic receipt storage region 45. As illustrated in FIG. 6, an electronic receipt stored in the electronic receipt storage region 45 is configured so as to be capable of being identified using identification information such as a member code, a transaction number, a company code, and a store code. Each electronic receipt includes store information such as store logotype data, a store telephone number, and an address. In addition, the electronic receipt includes merchandise information (a merchandise code, a merchandise name, a unit price, the number of merchandise items) for each merchandise item, and settlement information such as a subtotal, a tax amount, and a total price for one transaction. In addition, the electronic receipt stores a special content added thereto based on content addition conditions. In addition, information indicating a data storage destination (link) may be stored instead of the special content itself.

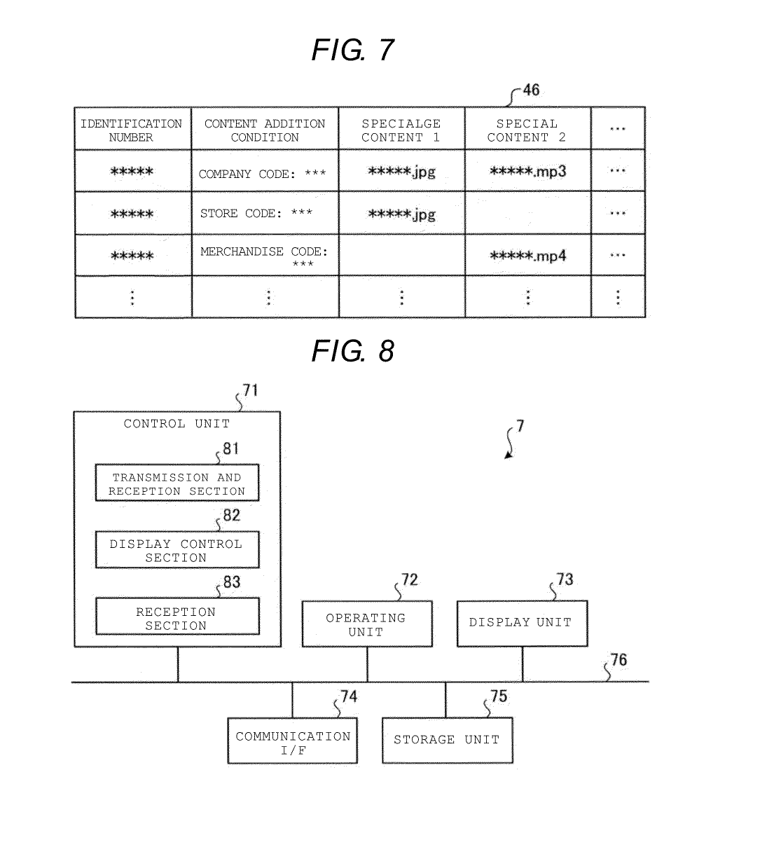

FIG. 7 illustrates an example of data stored in the content condition storage region 46. As illustrated in FIG. 7, in the content condition storage region 46, identification numbers of the respective conditions, content addition conditions, and information indicating a special content attached to an electronic receipt when the conditions are satisfied are associated with each other. In addition, in order to attach a plurality of special contents, such as an image file and a sound reproduction file, to an electronic receipt, a plurality of special contents (special content 1 and special content 2) may be set as illustrated in FIG. 7. In addition, a file format of the special content is not limited to a file format related to the extensions illustrated in FIG. 7.

The content addition condition may include a purchase action in any of particular chain stores or a purchase action in a specific store of particular chain stores. Alternatively, the purchase of specific merchandise, and the like may be appropriately set. In order to set purchase actions in all chain stores as conditions, a company code of a company managing the chain stores may be set as a content addition condition. In addition, in order to set a purchase action in a specific store as the condition, a store code may be set as the content addition condition. In addition, in order to set purchase of specific merchandise as a condition, a merchandise code of the merchandise may be set as a specific additional condition.

Referring back to FIG. 5, the storage unit 43 stores a program for causing the electronic receipt server 4 to perform the above-described processes. When the program is executed by the electronic receipt server 4, modules including a reception section 51, a content addition section 52, and a transmission section 53 are generated as illustrated in FIG. 5. The CPU of the control unit 31 develops the program to a RAM and executes the program, and thus the functions of the above-described sections are generated.

The reception section 51 receives an electronic receipt from the headquarter server 3 and stores the electronic receipt in the electronic receipt storage region 45. In addition, the reception section 51 receives various request data and response data from the portable terminal 7 through the network N4.

When transaction contents in the received electronic receipt match content addition conditions, the content addition section 52 selects a special content associated with the conditions from the content condition storage region 46. The extracted special content is associated with an electronic receipt to which the special content is to be included, and is then stored in the electronic receipt storage region 45.

The transmission section 53 reads out data stored in the electronic receipt storage region 45 in response to a data displaying request from the headquarter server 3 or the portable terminal 7 and transmits the data. In addition, the transmission section 53 appropriately converts the data format of the requested data in response to a data displaying request and outputs the converted data.

For example, when there is a request for displaying an electronic receipt from the headquarter server 3, the transmission section 53 generates display data to be displayed on a web page in accordance with conditions under which the displaying request is made, and transmits the generated display data to the headquarter server 3. In addition, when the portable terminal 7 accesses the web page by using a member code, the transmission section 53 transmits display data of an electronic receipt corresponding to the member code to the portable terminal 7. Alternatively, when the portable terminal 7 makes a displaying request through an application related to an electronic receipt, the transmission section 53 generates display data of an application screen and transmits the generated display data to the portable terminal 7.

(2-5) Portable Terminal

Next, a configuration example of the portable terminal 7 will be described. FIG. 8 is a block diagram of the portable terminal 7. In the portable terminal 7, a hardware configuration of a portable information processing apparatus which is generally used in the related art may be used. That is, as illustrated in FIG. 8, the portable terminal 7 includes a control unit 71 including a CPU, a ROM, a RAM, or the like. An operating unit 72 such as a touch panel or an operation key, a display unit 73 such as a liquid crystal display, a communication I/F 74, and a storage unit 75 are connected to the control unit 71 through a bus 76 and various interfaces. The control unit 71 may be connected to the network N4 through the communication I/F 74. Alternatively, the control unit 71 may be connected to the network N1 within a store through the communication I/F 74.

The storage unit 75 stores an application program related to an electronic receipt (an application related to an electronic receipt). When the application program related to an electronic receipt is executed, a module configuration including a transmission and reception section 81, a display control section 82, and a reception section 83 are generated as illustrated in FIG. 8. The CPU of the control unit 71 develops the program to a RAM and executes the program, and thus the functions of the above-described units are achieved.

The transmission and reception section 81 performs a process of transmitting and receiving data. That is, the transmission and reception section 81 transmits the member code stored in the storage unit 75 to the electronic receipt server 4, and requests the displaying of an electronic receipt. In addition, the transmission and reception section 81 transmits the member code stored in the storage unit 75 to the electronic receipt server 4, and requests the displaying of a content list screen (see FIGS. 11 and 13). In addition, the transmission and reception section 81 receives various display data transmitted from the electronic receipt server 4 in response to the displaying request.

The display control section 82 controls a process of displaying data on the display unit 73. For example, the display control section 82 operates to display various screens (see FIGS. 9 to 14) of the application related to an electronic receipt on the display unit 73, based on the display data received from the electronic receipt server 4 by the transmission and reception section 81.

The reception section 83 recognizes an operation such as an operation of selecting an icon displayed on a display screen through the operating unit 72.

(3) Configuration Example of Screen

Next, an example of a screen displayed on the portable terminal 7 will be described with reference to FIGS. 9 to 14. Hereinafter, an example of screen transition will also be described, but the procedure of screen transition is just an example and not limited to the following example.

In addition, a process of generating various display data may be performed by cooperation of the electronic receipt server 4 and the portable terminal 7 and by being shared by the electronic receipt server 4 and the portable terminal 7. The electronic receipt server 4 may transmit all of the display data. Alternatively, some of the display data may be stored in advance in the application related to an electronic receipt of the portable terminal 7 and may be used in the display process.

In addition, the portable terminal 7 displays screens (see FIGS. 9 to 14) using the application related to an electronic receipt, but may display the screens using a web browser or another application program.

(3-1) Examples of Start Screen

FIG. 9 illustrates an example of a start screen of an electronic receipt application. The display control section 82 operates to display the start screen as illustrated in FIG. 9 on the display unit 73 when an electronic receipt application is started. The display control section 82 includes a code symbol CS of a member code on the start screen based on image data stored in the storage unit 75. A customer (member) shows the start screen to a salesperson, and the salesperson scans the code symbol CS of the member code using the scanner 15 of the POS terminal 1. Thereby, the POS terminal 1 receives an input of the member code.

In addition, the start screen includes an icon 85 for viewing an electronic receipt and an icon 86 for viewing a content list screen (see FIGS. 11 and 13).

When the reception section 83 receives an operation of selecting the icon 85, the transmission and reception section 81 transmits an inquiry of an electronic receipt with the member code stored in the storage unit 75, to the electronic receipt server 4. In addition, the portable terminal 7 may display a screen for inputting a password and may transmit the input password to the electronic receipt server 4 together with the member code. The electronic receipt server 4 performs user authentication using the member code, the password, and information stored in the electronic receipt storage region 45. When the authentication may be successfully performed, download of electronic receipt data by the portable terminal 7 is permitted. The display control section 82 of the portable terminal 7 displays the electronic receipt of a purchase transaction on the display unit 73 based on the downloaded display data.

(3-2) Example of Display Screen of Electronic Receipt with Special Content

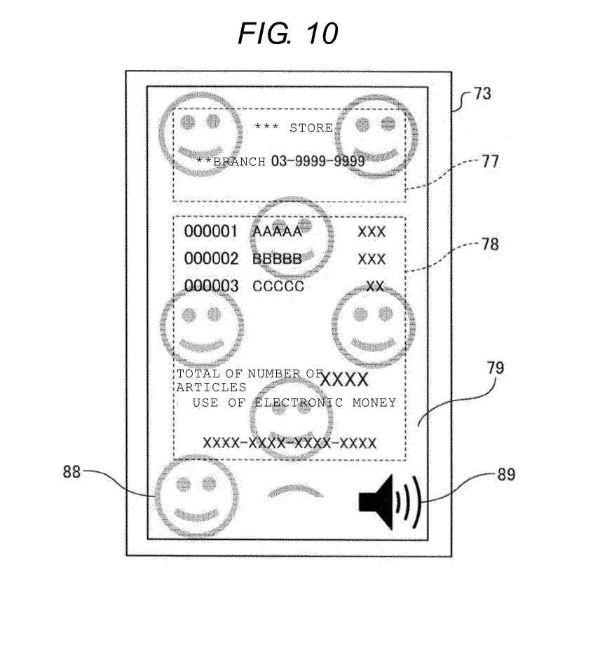

FIG. 10 illustrates an example of a display screen of an electronic receipt including a special content. FIG. 10 shows an example in which a background image 88 and a sound reproduction icon 89 are included in a screen as special contents.

As illustrated in FIG. 10, a store logotype area 77 is provided at an upper portion of a display area disposed on a front side, and a transaction data area 78 is provided below the store logotype area 77. In addition, a background area 79 is provided in a display area disposed on a rear side. The display data disposed on the front side has a display priority higher than display data disposed on the rear side. Accordingly, information, such as store data and transaction data, which may be important as an electronic receipt, a delivery card, an acknowledgment, and the like are displayed so as not to be hidden by the background image.

When music reproduction data (sound data) is included as a special content, the display control section 82 disposes the icon 89 functioning as a reproduction button in a display area different from the store logotype area 77 and the transaction data area 78. In addition, when a video data is used as a special content, the display control section 82 disposes a thumbnail of a video file or an icon functioning as a reproduction button (both are not shown in the drawing) in a display area different from the store logotype area 77 and the transaction data area 78.

(3-3) Special Content List Screen

Referring back to FIG. 9, when the reception section 83 recognizes an operation to select the icon 86, the transmission and reception section 81 transmits an inquiry of display data regarding a content list screen and the member code stored in the storage unit 75 to the electronic receipt server 4. The transmission section 53 of the electronic receipt server 4 transmits display data for displaying a content list screen to the portable terminal 7. The transmission and reception section 81 of the portable terminal 7 receives the display data regarding the content list screen, and the display control section 82 operates to display the content list screen based on the display data.

(3-3-1) Example of List Screen When Special Content is Not Acquired

Display Example When No Special Contents are Acquired

FIG. 11 illustrates an example of an initial screen of a content list screen. When a member has acquired no special content yet, only display frames 87 for displaying the special content are displayed on the content list screen. Numbers (No. 1, No. 2, . . . ) for identifying the special content are attached to each of the display frames 87. Identification numbers set in the content condition storage region 46 may be used as the numbers on the content list screen, or simplified numbers may be used.

In this manner, an area (display frame) for displaying the special content is provided in the content list screen in advance in accordance with a content number. When no special content is acquired, a blank is displayed, or a screen similar to the one for a special content is displayed. When such a list screen without the special content is displayed, the blank screen may promote a customer to have a desire to fill the blank screen or a desire to obtain and display other special contents. As a result, the screen may motivate the customer to do shopping.

The display control section 82 operates to display an image such as a question mark within the display frame 87 in which a special content is not included, and thus indicates that a special content has not been acquired. In addition, images such as a watermark image of a special content or a thumbnail which is equivalent to a special content may be displayed instead of the question mark. In addition, when special contents are background images or video data of a same series using the same character or the same type of motif, images, video data, or the like which are used in common in the series may be displayed. In this manner, it is possible to effectively motivate a customer to obtain a special content and display the special content by displaying images related to the special content which has not been acquired.

Display Example of Content Acquisition Condition

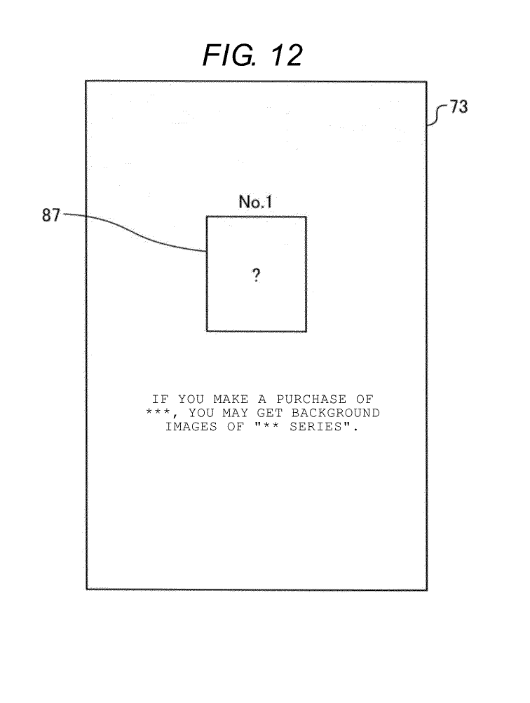

When the reception section 83 recognizes a touch operation with respect to a display region of the display frame 87 in which a special content has not been acquired, the display control section 82 displays a content acquisition condition for obtaining the special content associated with the display frame 87 on the display unit 73 (see FIG. 12).

FIG. 12 illustrates an example of a screen on which a content acquisition condition is displayed. FIG. 12 illustrates an example in which a message that shopping at a specific store is necessary to acquire the special content is displayed, as a content acquisition condition. However, the screen configuration is not limited to the example illustrated in FIG. 12. For example, a thumbnail of a special content, an image similar to the special content, or an image related to a content series may be displayed instead of the display frame 87 in which no image or only a question mark is displayed.

(3-3-2) Example of List Screen After Special Content is Acquired

FIG. 13 illustrates an example of the content list screen after a special content is acquired. FIG. 13 illustrates a case where special contents of No. 1 and No. 3 are acquired. The display control section 82 displays an image, video, a thumbnail, an icon for reproducing video data or sound data, and the like within the display frames 87, based on special contents downloaded from the electronic receipt server 4.

When the reception section 83 recognizes a touch operation with respect to the display region of the display frame 87 in which the special content has been acquired, the display control section 82 displays the special content on the entire screen (see FIG. 14).

(3-4) Example of Display Screen for Exclusive Use of Special Content

FIG. 14 illustrates an example of a content display screen. The content display screen is a screen on which a special content is displayed separately from an electronic receipt. In addition, the special content may be displayed on the entire screen of the display unit 73, or on a partial screen of the display unit 73.

(4) Example of Operation of System

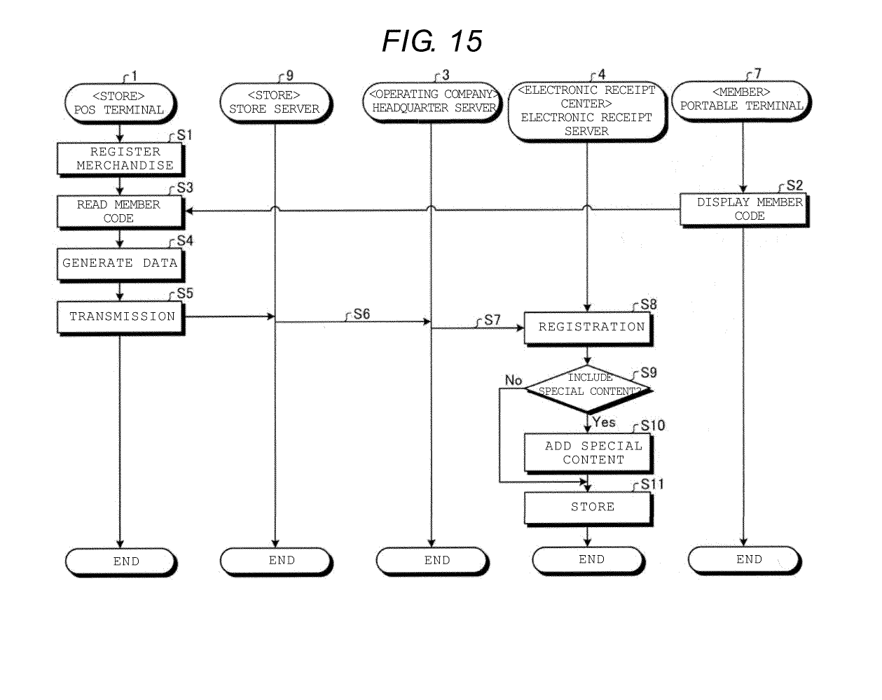

Next, an example of a process of generating an electronic receipt with a special content, which is performed by the electronic receipt system, will be described. FIG. 15 is a sequence diagram illustrating an example of a process of generating an electronic receipt with a special content performed by the electronic receipt system.

First, the sales registration section 21 of the POS terminal 1 registers merchandise by inputting merchandise information of merchandise to be purchased merchandise (step S1). As an example, a salesperson scans a merchandise code printed on the merchandise using the scanner 15 or manually inputs the merchandise code using the operating unit 12. The sales registration section 21 reads merchandise information, such as a merchandise name and a price, corresponding to the merchandise code from a merchandise master (not shown) stored in the storage unit 17, and stores the merchandise information in a RAM as information of merchandise to be sold.

Next, the code reception section 20 of the POS terminal 1 receives an input of a member code of the electronic receipt system. That is, a customer (member) causes the portable terminal 7 to start an application related to an electronic receipt system, and displays the above-described start screen (see FIG. 9) on the display unit 73 (step S2). Then, the customer shows the start screen to a salesperson, and the salesperson scans a code symbol CS displayed on the screen using the scanner 15 of the POS terminal 1. The code reception section 20 of the POS terminal 1 decodes the code symbol CS and receives an input of a member code (step S3).

The electronic receipt generation section 24 of the POS terminal 1 generates data of an electronic receipt including transaction data and a store code which are registered in step S1, the member code read in step S2, and the like (step S4).

The data output section 25 of the POS terminal 1 transmits the electronic receipt generated in step S4 to the store server 9 (step S5). The store server 9 outputs the electronic receipt to the headquarter server 3 when requested or at a predetermined timing (step S6). The headquarter server 3 outputs the electronic receipt to the electronic receipt server 4 when requested or at a predetermined timing (step S7).

The reception section 51 of the electronic receipt server 4 registers the received electronic receipt in the electronic receipt storage region 45 in association with a member code (step S8). Then, the content addition section 52 determines whether or not information satisfying a content acquisition condition is included in the transaction data, by referring to the content condition storage region 46 (step S9). When there is transaction data satisfying the content acquisition condition (step S9: Yes), the content addition section 52 determines that the transaction data is a target to which a special content is to be added, and the process proceeds to step S10.

The content addition section 52 reads a special content matched to the content acquisition condition from the content condition storage region 46 and adds the special content to an electronic receipt (step S10). That is, the special content is stored in the electronic receipt storage region 45 in association with the corresponding member code and the electronic receipt to which the special content is to be added (step S11).

On the other hand, when transaction data satisfying the content acquisition condition is not included in the electronic receipt (step S9: No), the process proceeds to step S11. The control unit 41 stores the electronic receipt in the electronic receipt storage region 45 in association with a member code (step S11), and a series of processes is terminated.

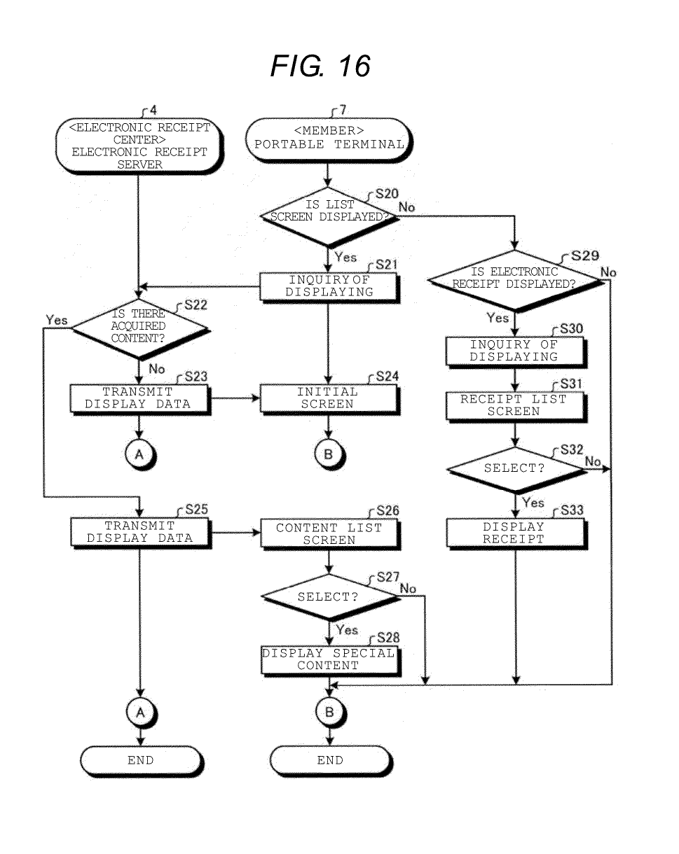

Next, a process of displaying a content list screen which is performed by the electronic receipt system will be described. FIG. 16 is a sequence diagram illustrating a process of displaying a content list screen which is performed by the electronic receipt system.

It is determined whether or not the reception section 83 of the portable terminal 7 receives an instruction to display the content list screen through a selecting operation of the icon 86 (see FIG. 9) (step S20). When the instruction to display the content list screen is not received (step S20: No), the process proceeds to step S29. When the instruction to display the content list screen is received (step S20: Yes), the transmission and reception section 81 requests the content list screen using the member code stored in the storage unit 75 (step S21).

The reception section 51 of the electronic receipt server 4 receives the request from the portable terminal 7 (step S21). The transmission section 53 refers to the electronic receipt storage region 45 with respect to a member code for which the request has been made. When there is not special content which is acquired (step S22: No), the transmission section 53 transmits display data such as a display frame and the above-described contents similar to a special content, to the portable terminal 7 (step S23). The display control section 82 of the portable terminal 7 displays an initial screen (see FIG. 11) of a content list screen using the received display data (step S24). Thereafter, the process proceeds to B in FIG. 16, a start screen (see FIG. 9) is displayed in accordance with an operation of a back button, a home button, or the like of the portable terminal 7, or the application is closed.

On the other hand, when there is at least one special content which is acquired (step S22: Yes), the transmission section 53 generates display data for displaying the special content on a content list screen. Then, the transmission section 53 transmits the generated display data to the portable terminal 7 (step S25). The display control section 82 of the portable terminal 7 displays a content list screen (see FIG. 13) on the display unit 73 based on the received display data (step S26).

Next, the reception section 83 of the portable terminal 7 determines whether or not an operation of selecting a special content is performed on a content list screen (step S27). When the selection operation is not performed (step S27: No), the process proceeds to B in FIG. 16 to perform the above-described processing. When the selection operation is performed (step S27: Yes), the display control section 82 separates contents of the selected special content from transaction data as illustrated in FIG. 14 and displays the contents in the entire display area of the display unit 73 (step S28). Thereafter, the process proceeds to B in FIG. 16 to perform the above-described processing.

On the other hand, the reception section 83 of the portable terminal 7 determines in step S29 whether or not an instruction for displaying an electronic receipt, such as an operation of selecting the icon 85 (see FIG. 9), is received. When the instruction for displaying an electronic receipt is not received (step S29: No), the process proceeds to B in the drawing to perform the above-described processing. When the instruction for displaying an electronic receipt is received (step S29: Yes), the transmission and reception section 81 inquires the displaying of the electronic receipt using the member code stored in the storage unit 75 (step S30).

Although not shown in FIG. 16, the transmission section 53 of the electronic receipt server 4 extracts display data of an electronic receipt for which a request has been made from the electronic receipt storage region 45 in accordance with a member code and the type of a displaying request, and transmits the display data to the portable terminal 7. In addition, the portable terminal 7 outputs search conditions (a date, a store name, a company name, and the like) which are input on the portable terminal 7, as a displaying request. Alternatively, the portable terminal outputs a request for displaying a list of all data by date, as a displaying request. Processes that are performed in the related art may be used as a request for displaying an electronic receipt and a process of displaying the electronic receipt, and thus details thereof will be omitted here.

The display control section 82 displays a receipt list screen on which a search result is displayed or a receipt list screen on which electronic receipts are sorted by date, on the display unit 73 (step S31). In the receipt list screen, texts of a transaction date, a store name, and a company name and a title of a company logotype mark and the like are displayed for each transaction. In addition, it is possible to display details of an electronic receipt in the transaction by performing an operation of selecting a title.

When any one electronic receipt is selected in the receipt list screen (step S32: Yes), the display control section 82 operates to display details of the selected electronic receipt (step S33). That is, the display control section 82 operates to display an electronic receipt including the store logotype area 77 and the transaction data area 78 (both are shown in FIG. 10) on the display unit 73. When a special content is attached to the electronic receipt, the display control section 82 operates to display the electronic receipt inclusive of contents (the background image 88 and the sound reproduction icon 89 in the example of FIG. 10) of the special content as illustrated in FIG. 10. Thereafter, the process proceeds to B in FIG. 16 to perform the above-described processing.

In the present embodiment, other devices may have the functions of the above-described devices, and a plurality of information processing apparatuses connected to a network may share the functions. In addition, the portable terminal 7 may have the function of the electronic receipt server 4, and the electronic receipt server 4 may have the function of the portable terminal 7.

In the present embodiment, an application program installed in the portable terminal 7 may add a special content in accordance with transaction data, and a special content which is acquired may be managed by the storage unit 75. In this case, the portable terminal 7 may also receive an electronic receipt through the network N1 within a store or a near field wireless communication (not shown) from the POS terminal 1 instead of the electronic receipt server 4.

With Regard to Exclusive Use of Special Content

The portable terminal 7 may be set so that a special content acquired in the above-described manner may be used for other purposes. For example, the portable terminal 7 may set image data which is added to an electronic receipt as a special content, as background display data, such as wallpaper, of a screen other than an electronic receipt display screen. In addition, the portable terminal 7 may set sound reproduction data which is added to an electronic receipt as a special content, as an incoming sound or a notification sound.

As described above, according to the present embodiment, with respect to special contents associated with purchase in a store or the purchase of merchandise, a customer generates display data of a list screen of special contents already acquired and outputs the display data. Thereby, the customer may collectively view the acquired special contents in the list screen displayed in a portable terminal. In this manner, according to the present embodiment, it is possible to provide an information processing apparatus and program capable of easily viewing a special content already acquired.

With Regard to Additional Data Other Than Special Content

In the above, a special content is added to an electronic receipt for promotion of merchandise or store is described, but the added content (data) may not be used for promotion. That is, the electronic receipt server 4 may add other additional data, which are not limited to a promotional content, to an electronic receipt and cause the portable terminal 7 to display a list of the additional data.

That is, according to the present embodiment, it is possible to extract additional data of an electronic receipt from the electronic receipt and to display a list of the additional data on a list screen. In this manner, in the present embodiment, data organization focused on additional data is performed, and thus the customer can view the additional data conveniently. Therefore, when additional data includes an advertisement, it is possible to promote customers to view the advertisement and to achieve sales promotion.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A graphical user interface implemented in a mobile computing device of a user, comprising:
a plurality of user selectable regions including first and second user selectable regions, the first user selectable region being associated with a first product and displaying a first image, and the second user selectable region being associated with a second product and displaying a second image different from the first image; and
a processor configured to recognize a selection of one of the user selectable regions, wherein
when the processor recognizes a user selection on the first user selectable region, the processor causes an enlarged version of the first image to be displayed, and
when the processor recognizes a user selection on the second user selectable region, the processor causes a third image to be displayed, the third image containing elements of a sales promotion for the second product.

2. The graphical user interface according to claim 1, wherein
after the processor recognizes the user selection on the first user selectable region, the processor causes an electronic receipt to be displayed with the enlarged first image.

3. The graphical user interface according to claim 2, wherein
the enlarged first image is displayed as a background image of the electronic receipt.

4. The graphical user interface according to claim 2, wherein
the first image is associated with sound data, and the processor causes the sound data to be reproduced while the electronic receipt is displayed.

5. The graphical user interface according to claim 4, wherein
the first image includes an image portion that indicates that the first image is associated with sound data.

6. The graphical user interface according to claim 1, wherein
the element of the sales promotion includes a message indicating that a fourth image instead of the third image can be displayed in the second user selectable region if the second product is purchased.

7. A method for displaying a graphical user interface on a display unit of a mobile computing device of a user, comprising:
displaying a plurality of user selectable regions including first and second user selectable regions, the first user selectable region being associated with a first product and displaying a first image, and the second user selectable region being associated with a second product and displaying a second image different from the first image;
recognizing a selection of one of the user selectable regions;
when a user selection on the first user selectable region is recognized, displaying an enlarged version of the first image; and
when a user selection on the second user selectable region is recognized, displaying a third image containing elements of a sales promotion for the second product.

8. The method according to claim 7, wherein
after the user selection on the first user selectable region is recognized, displaying an electronic receipt with the enlarged first image.

9. The method according to claim 8, wherein
the enlarged first image is displayed as a background image of the electronic receipt.

10. The method according to claim 8, wherein the first image is associated with sound data, and the method further comprises:
reproducing the sound data while the electronic receipt is displayed.

11. The method according to claim 10, wherein
the first image includes an image portion that indicates that the first image is associated with sound data.

12. The method according to claim 7, further comprising:
recognizing, at a server, whether or not the second product has been purchased by the user; and
when it is recognized that the second product has been purchased, displaying a fourth image instead of the second image in the second user selectable region.

13. The method according to claim 7, wherein
the element of the sales promotion includes a message indicating that a fourth image instead of the third image can be displayed in the second user selectable region if the second product is purchased.

14. A server comprising:
a storage unit storing electronic receipt data of one or more purchase transactions in association with a user code of a user involved in the purchase transactions, first image data associated with a first product purchased through the purchase transactions, and second image data associated with a second product that has not been purchased through the purchase transactions;
a control unit configured to generate data of a graphic user interface including a plurality of user selectable regions including first and second user selectable regions, the first user selectable region being associated with the first product and including a first image corresponding to the first image data, and the second user selectable region being associated with the second product and including a second image that is different from the first image and corresponds to the second image data; and
a communication unit configured to transmit the generated data to a computing device associated with the user code.

15. The server according to claim 14, wherein
the data is generated in response to the communication unit receiving a request from the computing device.

16. The server according to claim 14, wherein
when the first user selectable region is selected, an enlarged version of the first image is displayed in the graphic user interface, and
when the second user selectable region is selected, a third image containing elements of a sales promotion for the second product is displayed in the graphic user interface.

17. The server according to claim 14, wherein
the storage unit further stores sound data in association with the first image data, and
when the first user selectable region is selected, the sound data is reproduced.

18. The server according to claim 17, wherein
the first image includes an image portion that indicates that the first image is associated with sound data.

19. The server according to claim 14, wherein
the element of the sales promotion includes a message indicating that a third image different from the second image can be displayed in the second user selectable region if the second product is purchased.
